(19) United States
(12) Patent Application Publication
(10) Pub. No.: US 2003/0076189 A1
(43) Pub. Date: Apr. 24, 2003

(54) Stripline coupling

(76) Inventor: Calin Moldoveanu, Thornhill (CA)

Correspondence Address: Robert Graham, Gowling Lafleur Henderson LLP, Suite 4900, Commerce Court West, Toronto, ON, M5L 1J3, CA

(21) Appl. No.: 10/265,192

(22) Filed: Oct. 7, 2002

Related U.S. Application Data
(63) Continuation of application No. PCT/CA01/00465, filed on Apr. 5, 2001.

(30) Foreign Application Priority Data
Apr. 6, 2002 (CA) 2,303,976

(51) Int. Cl. H01P 5/10

(52) U.S. Cl. 333/26; 333/33

(57) ABSTRACT

A stipline coupling includes a balun-configured stripline, and a transformer-configured stripline coupled to the balun-configured stripline. The balun-configured stripline includes a pair of conductors, one of which includes a pair of coplanar conductive paths. One of the conductive paths is grounded to provide equal magnitude opposite phase signals to the transformer-configured stripline. The transformer-configured stripline impedance matches the opposite phase signals to the balanced transmission line. The transformer-configured stripline includes two conductive trace sections, one of which includes a pair of substantially abutting non-contacting conductive trace portions. The conductive trace portions of the one trace section includes fingers extending from the respective trace portion. The fingers of one of the fingered traces are interlaced with the fingers of the other fingered traces. Links extend between the fingers of the one trace section and the trace portions of the other trace section for cross-coupling the trace portions together.

### FIELD OF INVENTION

The present invention relates to a transmission line coupling. In particular, the present invention relates to a stripline coupling for effecting electrical signal transmission between a balanced transmission line and un unbalanced transmission line.

### BACKGROUND OF THE INVENTION

Most communication systems include either balanced or unbalanced transmission lines. A balanced transmission line may be defined as a transmission line having a pair of conductors configured to carry electrical signals which are 180° out of phase with respect to each other. In contrast, the typical unbalanced transmission line includes only a single conductor, with signal return being provided by a ground return path.

As will be apparent, unbalanced transmission lines are desirable due their intrinsically low manufacturing costs. On the other hand, balanced transmission lines are desirable for their enhanced ability to transfer power to a load, and their enhanced immunity to noise. Therefore, many communications systems includes both balanced and unbalanced transmission lines, interconnected by a suitable coupling.

To facilitate an efficient transfer of signal power between a balanced transmission line and an unbalanced transmission line, baluns are often used as the coupling between the adjoining transmission lines. A balun is a form of transformer which splits the unbalanced energy from the unbalanced transmission line into two equal paths, having equal magnitude and opposite phase, for communication with the two inputs of the balanced transmission line. The balun is also advantageous in its ability to match the impedance required by the unbalanced transmission line with the impedance required by the balanced transmission line.

Although many forms of baluns are presently available, a common limitation is their inability to impedance match over a wide frequency range, such as the range required by VHF and UHF broadcast power amplifiers. The most common solution to this problem has been to cascade a balun with a transmission line transformer. With this arrangement, the balun is used primarily for the separation of the unbalanced energy from the unbalanced transmission line into two equal paths, while the transmission line transformer is used for impedance matching with the balanced transmission line.

Typically, the balun and the transmission line transformer are each fabricated from sections of flexible or semi-rigid coaxial cable. Although this configuration provides acceptable wideband performance, the available impedance ratio is limited by the variety of coaxial cables presently available. Also, this configuration requires a significant amount of manual labour for assembly, thereby contributing to the manufacturing cost of the balun and the transformer.

Accordingly, there remains a need for a transmission line coupling for facilitating wideband electrical signal transmission between a balanced transmission line and an unbalanced transmission line in a cost effective manner.

### SUMMARY OF THE INVENTION

According to the present invention, there is provided a stripline coupling which addresses deficiencies of the prior art.

The stripline coupling, according to the present invention, is provided for coupling an unbalanced transmission line to a balanced transmission line, and includes a balun-configured stripline, and a transformer-configured stripline in communication with the balun-configured stripline. The balun-configured stripline is configured for providing a pair of intermediate opposite-phase signals from an unbalanced signal received from the unbalanced transmission line. The transformer-configured stripline impedance matches the intermediate signals to the balanced transmission line.

The balun-configured stripline includes a pair of conductors, one of the conductors being configured with a pair of coplanar conductive paths. One of the conductive paths is grounded for providing the opposite-phase signals as equal magnitude opposite-phase signals to the transformer-configured stripline.

The transformer-configured stripline includes two spaced-apart conductive trace sections, at least one including a pair of substantially abutting non-contacting conductive trace portions. The conductive trace portions of one of the trace sections includes at least one finger each extending from the respective trace portion. The fingers of one of the fingered traces are interlaced with the fingers of the other fingered traces. A plurality of links extend between the fingers of the one trace section and the trace portions of the other trace section for cross-coupling the trace portions together.

Preferably, the balun-configured stripline and the transformer-configured stripline are fabricated on a common substrate to reduce costs and complexity of manufacture.

### BRIEF DESCRIPTION OF THE DRAWINGS

The preferred embodiments of the present invention will now be described, by way of example only, with reference to the drawings, in which:

FIG. 1 is a perspective view of a conventional stripline, depicting the three substrates and the two conductive traces disposed between the substrates;

FIG. 2 is a perspective view of the stripline coupling, according to the present invention, depicting the balun-configured stripline and the 4:1 transformer-configured stripline;

FIG. 3 is a magnified view of the link connections between the trace portions of the transformer-configured stripline shown in FIG. 2;

FIG. 4 is a schematic diagram of the 4:1 transformer-configured stripline shown in FIGS. 2 and 3;

FIG. 5 is a graph depicting the frequency response of a UHF amplifier obtained by transmitting a TV band through the stripline coupling shown in FIGS. 2 and 3;

FIG. 6 is a perspective view of a 9:1 transformer-configured stripline, being a variation of the 4:1 transformer-configured stripline shown in FIG. 2;

FIG. 7 is a magnified view of the link connections between the trace portions of the transformer-configured stripline shown in FIG. 6; and

FIG. 8 is a schematic diagram of the 9:1 transformer-configured stripline shown in FIGS. 6 and 7.

### DETAILED DESCRIPTION OF THE PREFERRED EMBODIMENTS

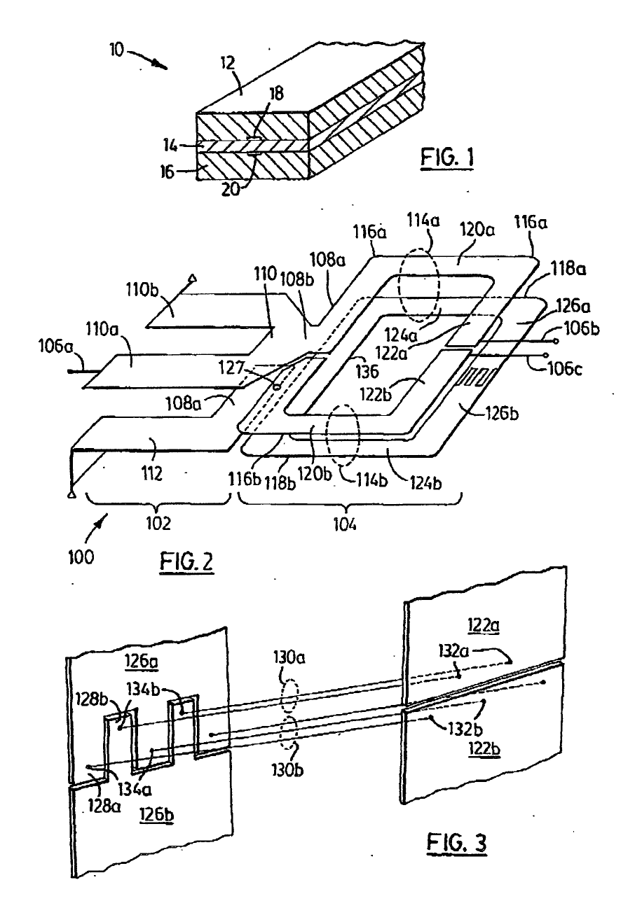

To aid in the understanding of the stripline coupling, according to the present invention, a conventional stripline will be described first, followed by a description of the stripline coupling. Turning initially to FIG. 1, a conventional broadside-coupled stripline transmission line 10 is shown comprising three stacked planar printed circuit boards 12, 14, 16 and two transmission lines 18, 20 provided between the printed circuit boards 12, 14, 16. The transmission lines 18, 20 are usually photo-etched onto opposite faces of the centre printed circuit board 14, and then the printed circuit boards 12, 14, 16 are typically secured together face-to-face with glue.

The printed circuit boards 12, 14, 16 are fabricated from a material having a uniform dielectric constant. The outer surfaces of the printed circuit boards 12, 16 are metalized and grounded so as to emulate the characteristics of a coaxial transmission line. As will be apparent, the characteristic impedance, Zo can be adjusted by altering the dimensions of the transmission lines 18, 20, and the dimensions and the dielectric constant of the printed circuit boards 12, 14, 16.

Turning now to FIG. 2, a stripline coupling, denoted generally as 100, is shown for coupling an unbalanced transmission line to a balanced transmission line. The stripline coupling 100 comprises a balun-configured stripline 102 and a transformer-configured stripline 104. The balun-configured stripline 102 and the transformer-configured stripline 104 are preferably fabricated together on a common substrate (circuit board 14), in accordance with the manufacturing techniques of the conventional broad-side coupled stripline discussed above. However, the characteristic impedance and the coupling of the balun-configured stripline 102 and the transformer-configured stripline 104 can be controlled separately by altering the line width of each transmission line.

The balun-configured stripline 102 includes a signal input 106a for receiving an unbalanced input signal from an unbalanced transmission line, and first and second intermediate signal outputs 108a, 108b for providing two intermediate output signals to the transformer-configured stripline 104. The balun-configured stripline 102 is implemented as a broadside-coupled stripline, comprising an upper conductor 110 for receiving the unbalanced input signal, and a lower conductor 112 parallel to and spaced from the upper conductor 110. The lower conductor 112 is typically grounded and acts as a return current path for the unbalanced input signal.

The upper conductor 110 comprises first and second coplanar conductive paths 110a, 110b. The first conductive path 110a carries the unbalanced input signal, and the second conductive path 110b is connected to ground to ensure that the two intermediate signals at the intermediate signal outputs 108 have equal amplitude but opposite phase.

The transformer-configured stripline 104 is coupled to the balun-configured stripline 102, and includes two signal outputs 106b, 106c for providing impedance matched output signals to the balanced transmission line, based on the intermediate signals received from the balun-configured stripline 102. The transformer-configured stripline 104 is implemented as a two coplanar broadside-coupled striplines, and comprises a first stripline 114a coupled to the first intermediate output 108a for providing the first output signal at the first signal output 106b and a second stripline 114b coupled to the second intermediate output 108b for providing a second output signal at the second signal output 106c.

The first stripline 114a comprise a first upper conductive trace 116a, and a first lower conductive trace 118a parallel to and spaced apart from the first upper conductive trace 116a. Preferably, the first upper conductive trace 116a includes a first upper major conductive trace portion 120a, and a first upper conductive trace end portion 122a disposed at a right angle to the first upper major conductive trace portion 120a. Similarly, preferably the first lower conductive trace 118a includes a first lower major conductive trace portion 124a, and a first lower conductive trace end portion 126a disposed at a right angle to the first lower major conductive trace portion 124a.

Similarly, the second stripline 114b comprises a second upper conductive trace 116b, and a second lower conductive trace 118b parallel to and spaced apart from the second outer conductive trace 116b. The second upper conductive trace 116b is connected to the lower conductor 112 of the balun-configured stripline 102 by a plated through-hole 127 which extends transversely through the substrate (circuit board 14), between the second upper conductive trace 116b and the lower conductor 112, but which does not contact the second lower conductive trace 118b. Preferably, the second upper conductive trace 116b includes a second upper major conductive trace portion 120b, and a second upper conductive trace end portion 122b disposed at a right angle to the second upper major conductive trace portion 120b. Preferably the second lower conductive trace 118b includes a second lower major conductive trace portion 124b, and a second lower conductive trace end portion 126b disposed at a right angle to the second lower major conductive trace portion 124b.

Preferably, the first and second upper conductive traces 116a, 116b and the first and second upper conductive trace end portions 122a, 122b are coplanar with the upper conductor 110 of the balun-configured stripline 102, and are all fabricated on a common side of the substrate (circuit board 14). Similarly, preferably the first and second lower conductive traces 124a, 124b and the first and second lower conductive trace end portions 126a, 126b are coplanar with the lower conductor 112 of the balun-configured stripline 102, and are all fabricated on the opposite side of the substrate 14.

As shown in FIG. 3, the first upper conductive trace end portion 122a substantially abuts with the second upper conductive trace end portion 122b. However, the first upper conductive trace end portion 122a is spaced from the second upper conductive trace end portion 122b and, accordingly, does not contact the second upper conductive trace end portion 122b.

Similarly, the first lower conductive trace end portion 126a substantially abuts with the second lower conductive trace end portion 126b. The first lower conductive trace end portion 126a is spaced from the second lower conductive trace end portion 126b and, accordingly, does not contact the second lower conductive trace end portion 126b.

The first lower conductive trace end portion 126a includes a plurality of coplanar first fingers 128a extending in parallel towards the second lower conductive trace end portion 126b. Similarly, the second lower conductive trace end portion 126b includes a plurality of coplanar second fingers 128b extending in parallel towards the first lower conductive trace end portion 126a. The first fingers 128a are interlaced with the second fingers 128b but do not contact the second fingers 128b.

Alternately, or in addition to the fingers 128a, 128b, in one variation (not shown), the first upper conductive trace end portion 122a includes a plurality of coplanar first fingers 128a″ extending in parallel towards the second upper conductive trace end portion 122b, and the second upper conductive trace end portion 122b includes a plurality of coplanar second fingers 128b′ extending in parallel towards the first upper conductive trace end portion 122a. The first fingers 128a′ are interlaced with the second fingers 128b′ and do not contact the second fingers 128b′.

The stripline coupling 100 includes a plurality of first conductive links 130a, fabricated as plated through-holes, which extend transversely through the substrate 14 between the first upper conductive trace end portion 122a and the second lower conductive trace end portion 126b for electrically coupling together the first upper conductive trace 116a with the second lower conductive trace 118b. The stripline coupling 100 also includes a plurality of second conductive links 130b, fabricated as plated through-holes, which extend transversely through the substrate 14 between the second lower conductive trace end portion 122b and the first upper conductive trace end portion 126a for electrically coupling together the second upper conductive trace 116b with the first lower conductive trace 118a. Preferably, the through-holes are equidistantly spaced so that the links 130 are substantially parallel to each other. As will be appreciated, the foregoing arrangement electrically cross-couples the conductive trace portions 116, 118 together at the end portions 122, 126.

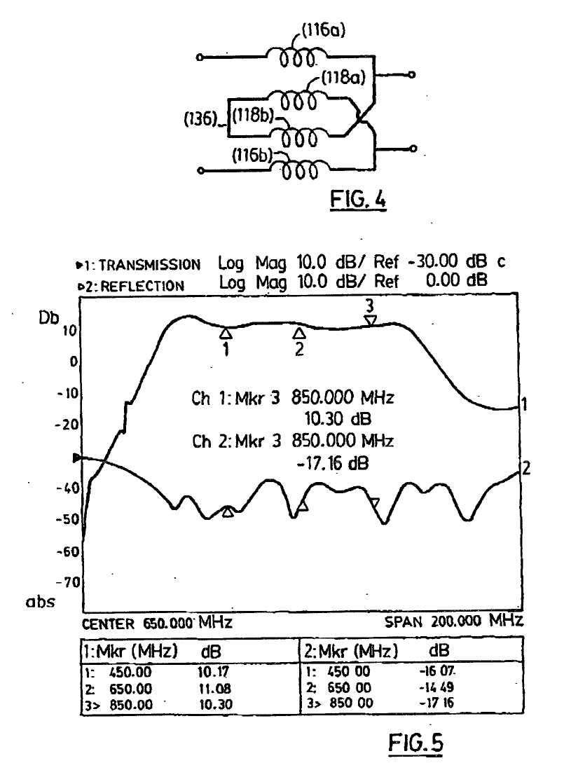

The stripline coupling 100 also includes a short-circuit link 136 connected between the first inner conductive trace end portion 126a and the second inner conductive trace end portion 126b for electrically short-circuiting the conductive trace portions 124a, 124b together at the end opposite the end portions 126a, 126b. The short-circuit link 136 is coplanar with the first and second lower conductive traces 124a, 124b, the first and second lower conductive trace end portions 126a, 126b, and the lower conductor 112 of the balun-configured stripline 102. As will be appreciated, the resulting transformer-configured stripline 104 mimics the operation of the 4:1 transmission line transformer shown in FIG. 4, with the balanced signal outputs 106b, 106c of the transformer 104 preferably being tapped from the first and second upper conductive trace end portions 122a, 122b. However, the present invention results in a larger bandwidth and higher impedance transformer ratios than those which can be achieved with a coaxial cable-based 4:1 transmission line transformer, and without a significant increase in complexity. For convenience, the constituent elements of the 4:1 transformer shown in FIG. 4 are denoted, in brackets, with the reference numerals of the corresponding elements of the transformer-configured stripline 104.

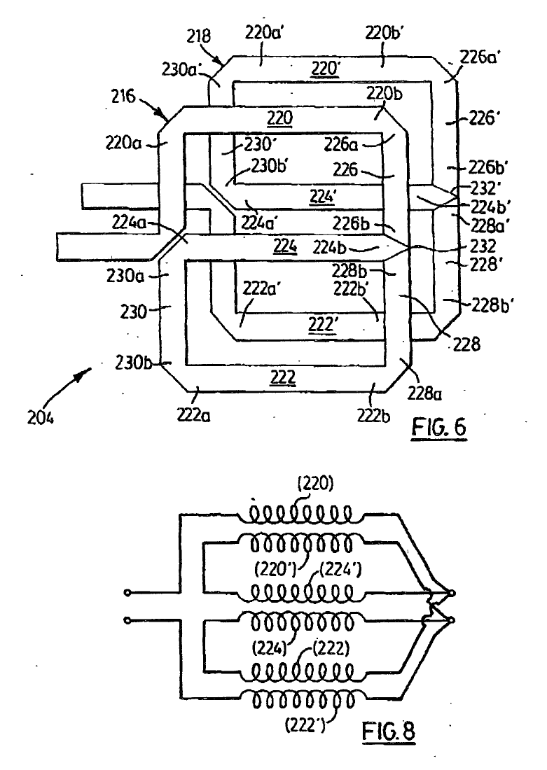

In one implementation of the stripline coupling 100, the printed circuit boards are fabricated from G200 with a dielectric constant of 4. The upper and lower printed circuit boards 12, 16 are 0.125 inches thick, and the middle printed circuit board 14 is 0.025 inches thick. The transmission lines 18, 20 comprising the balun-configured transformer 102 are 0.155 inches in width, while the transmission lines 18, 20 comprising the transformer-configured transformer 104 are 0.125 inches in width. The transmission and reflection obtained with the transmission of a UHF TV band through the stripline coupling 100 is shown in FIG. 5.

A variation of the transformer-configured stripline 104 is shown in FIG. 6. The transformer-configured stripline 204, shown in FIG. 6 is implemented as a broadside-coupled stripline, and comprises a first transmission line 216 coupled to the first intermediate output 108a and a second transmission line 218 coupled to the second intermediate output 108b. As above, the first and second transmission lines 216, 218 are fabricated on opposite sides of a common substrate (circuit board 14), so that the first transmission line 216 is parallel to and spaced apart from the second transmission line 218.

The first transmission line 216 is configured as a spiral conductive trace, and comprises a first upper conductive trace portion 220, a second upper conductive trace portion 222, a third upper conductive trace portion 224, a first upper short-circuit trace end portion 226, a second upper short-circuit trace end portion 228, and a third upper short-circuit trace end portion 230. The first upper conductive trace portion 220 includes a first end 220a for receiving a first balanced input signal to the transformer 204, and a second end 220b opposite the first end 220a. Similarly, the second upper conductive trace portion 222 includes a first end 222a and a second end 222b opposite the first end 222a, and the third upper conductive trace portion 224 includes a first end 224a, and a second end 224b opposite the first end 224a. Preferably, the first, second and third upper conductive trace portions 220, 222, 224 are coplanar and oriented parallel to each other.

The first upper short-circuit trace end portion 226 includes a first end 226a and a second end 226b, and the second upper short-circuit trace end portion 228 includes a first end 228a and a second end 228b. The first and second upper short-circuit trace end portions 226, 228 are in series with each other, and are provided between the first and second upper conductive trace portions 220, 222, at the second ends 220b, 222b, for short circuiting the first and second upper conductive trace portions 220, 222 together at the second ends 220b, 222b. The third upper short-circuit trace end portion 230 is provided between the second and third upper conductive trace portions 222, 224 at the first ends 222a, 224a, for short circuiting the second and third upper conductive trace portions 222, 224 together at the first ends 222a, 224a. The first transmission line 216 also includes an upper junction 232, disposed at the point of common connection of the second ends 226b, 228b of the first and second upper short-circuit trace end portions 226, 228, for providing the first balanced output signal of the transformer 204.

Similarly, the second transmission line 218 is configured as a spiral conductive trace, and comprises a first lower conductive trace portion 220′, a second lower conductive trace portion 222′, a third lower conductive trace portion 224′, a first lower short-circuit trace end portion 226′, a second lower short-circuit trace end portion 228′, and a third short-circuit trace end portion 230′. The first upper conductive trace portion 220′ includes a first end 220a′ and a second end 220b′ opposite the first end 220a′. Similarly, the second upper conductive trace portion 222′ includes a first end 222a′ for receiving a second balanced input signal to the transformer 204, and a second end 222b′ opposite the first end 222a′. The third upper conductive trace portion 224′ includes a first end 224a′ and a second end 224b′ opposite the first end 224a′. Preferably, the first, second and third upper conductive trace portions 220′, 222′, 224′ are coplanar and oriented parallel to each other.

The first lower short-circuit trace end portion 226′ includes a first end 226a′ and a second end 226b;, and the second lower short-circuit trace end portion 228′ includes a first end 228a′ and a second end 228b′. The first and second lower short-circuit trace end portions 226, 228 are in series with each other, and are provided between the first and second lower conductive trace portions 220′, 222′, at the second ends 220b′, 222b′, for short circuiting the first and second lower conductive trace portions 220′, 222′ together at the second ends 220b′, 222b′. The third lower short-circuit trace end portion 230′ is provided between the second and third lower conductive trace portions 222′, 224′ at the first ends 222a′, 224a′, for short circuiting the second and third lower conductive trace portions 222′, 224′ together at the first ends 222a′, 224a′. The second transmission line 218 also includes a lower junction 232′, disposed at the point of common connection of the second ends 226b′, 228b′ of the first lower short-circuit trace end portion 226′ and the second lower short-circuit trace end portion 228′, for providing the second balanced output signal of the transformer 204.

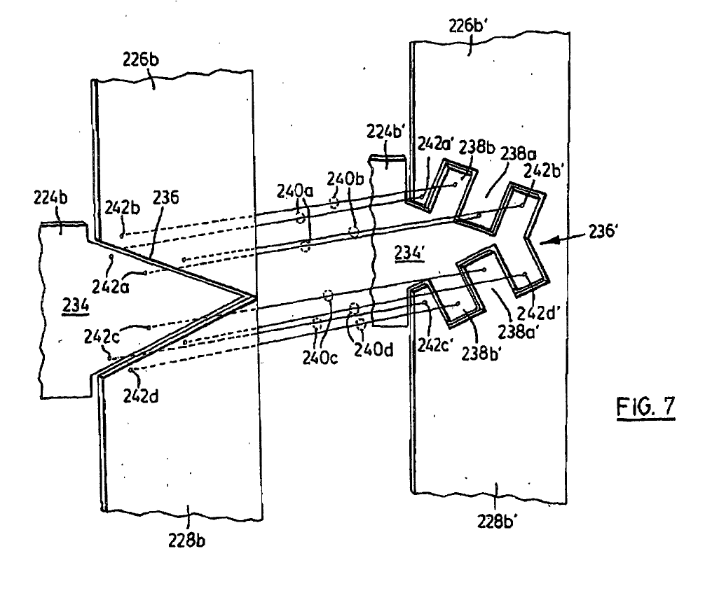

As shown in FIG. 7, the second end 224b of the third upper conductive trace portion 224 terminates in an upper triangular-shaped end portion 234. The first upper short-circuit trace end portion 226 is tapered adjacent the second end 226b, and the second upper short-circuit trace end portion 228 is similarly tapered adjacent the second end 228b so as to define together an upper triangular-shaped cut-out portion 236 shaped to receive the upper triangular-shaped end portion 234. The upper triangular-shaped end portion 234 is coplanar with the first and second upper short-circuit trace end portions 226, 228 and is positioned in a substantially abutting manner with the upper triangular-shaped cut-out portion 236. However, consistent with the previous embodiment, the upper triangular-shaped end portion 234 of the third upper conductive trace 224 is spaced from the first and second upper short-circuit trace end portions 226, 228 at the upper cut-out portion 236. Accordingly, the third upper conductive trace portion 224 does not contact either of the first or second upper short-circuit trace end portions 226, 228.

Similarly, the second end 224b′ of the third lower conductive trace portion 224′ terminates in a lower triangular-shaped end portion 234′. The first lower short-circuit trace end portion 226′ is tapered adjacent the second end 226b′, and the second lower short-circuit trace end portion 228′ is similarly tapered adjacent the second end 228b′ so as to define together a lower triangular-shaped cut-out portion 236′ shaped to receive the lower triangular-shaped end portion 234′. The lower triangular-shaped end portion 234′ is coplanar with the first and second lower short-circuit trace end portions 226′, 228′ and is positioned in a substantially abutting manner with the lower triangular-shaped cut-out portion 236′. Again, consistent with the previous embodiment, the lower triangular-shaped end portion 234′ of the second end 224b′ of the third lower conductive trace 224′ is spaced from the first and second lower short-circuit trace end portions 226′, 228′ at the lower cut-out portion 236′. Accordingly, the third lower conductive trace portion 224′ does not contact either of the first or second lower short-circuit trace end portions 226′, 228′.

The second end 226b′ of the first lower short-circuit trace end portion 226′ includes a plurality of coplanar first fingers 238a extending in parallel towards the lower triangular-shaped end portion 234′. The lower triangular-shaped end portion 234′ also includes a plurality of coplanar second fingers 238b extending in parallel towards the second end 226b′ of the first lower short-circuit trace end portion 226b′. The first fingers 238a are interlaced with the second fingers 238b but do not contact the second fingers 238b.

Similarly, the second end 228b′ of the second lower short-circuit trace end portion 228′ includes a plurality of coplanar third fingers 238a′ extending in parallel towards the lower triangular-shaped end portion 234′. The lower triangular-shaped end portion 234′ also includes a plurality of coplanar fourth fingers 238b′ extending in parallel towards the second end 228b′ of the second lower short-circuit trace end portion 228′. The third fingers 238a′ are interlaced with the fourth fingers 238b′ but do not contact the third fingers 238b′.

The transformer 204 includes a plurality of first transmission line links 240a, fabricated as through-holes, extending transversely through the substrate (circuit board 14) between the first lower short-circuit trace end portion 226′ and the upper triangular-shaped end portion 234 for coupling together the first lower conductive trace portion 220′ with the third upper conductive trace portion 224. The transformer 204 also includes a plurality of second transmission line links 240b, fabricated as through-holes, extending transversely through the substrate 14 between the lower triangular-shaped end portion 234′ and the first upper short-circuit trace end portion 226 for coupling together the third lower conductive trace portion 224′ with the first upper conductive trace portion 220.

The transformer 204 also includes a plurality of third transmission line links 240c, fabricated as through-holes, extending transversely through the substrate 14 between the second lower short-circuit trace end portion 228′ and the upper triangular-shaped end portion 234 for coupling together the second lower conductive trace portion 222′ with the third upper conductive trace portion 224. A plurality of fourth transmission line links 240d is also included, fabricated as through-holes, extending transversely through the substrate 14 between the lower triangular-shaped end portion 234′ and the second upper short-circuit trace end portion 228 for coupling together the third lower conductive trace portion 224′ with the second upper conductive trace portion 222. Preferably, the through holes are equidistantly spaced for maintaining the links 240 substantially parallel to each other.

The foregoing arrangement couples the third upper conductive trace portion 224 with the first lower conductive trace portion 220′ and the second lower conductive trace portion 222′, and also couples the third lower conductive trace portion 224′ with the first upper conductive trace portion 220 and the second lower conductive trace portion 222. As will be appreciated, the resulting transformer 204 mimics the operation of the 9:1 transmission line transformer shown in FIG. 8. For convenience, the constituent elements of the 9:1 transformer shown in FIG. 8 are denoted, in brackets, with the reference numerals of the corresponding elements of the transformer-configured stripline 204.

The foregoing description is intended to be illustrative of the preferred embodiments of the present invention. Those of ordinary skill many envisage certain additions, deletions and/or modifications to the describe embodiments which, although not explicitly described herein, do not depart from the spirit or scope of the present invention, as defined by the claims appended hereto.

We claim:

1. A stripline coupling for coupling an unbalanced transmission line to a balanced transmission line, the transmission line coupling comprising:
a balun-configured broadside-coupled stripline for providing a pair of intermediate opposite-phase signals from an unbalanced signal received from the unbalanced transmission line; and
a transformer-configured broadside-coupled stripline coupled to the balun-configured stripline for impedance matching the intermediate signals to the balanced transmission line, the striplines each comprising conductive traces disposed on opposite sides of a common dielectric, the conductive traces being disposed between a pair of ground planes.

2. The stripline coupling according to claim 1, wherein the conductive traces of the transformer-configured stripline includes two spaced-apart conductive trace sections, each of the conductive trace sections including a pair of substantially abutting non-contacting conductive trace portions, the conductive trace portions of one of the trace sections including at least one finger extending from said respective trace portion, the fingers of one of the fingered trace portions being interlaced with the fingers of the other fingered trace portion, and a plurality of links extending between the fingers of the one trace section and the trace portions of the other trace section for cross-coupling the trace portions together.

3. The stripline coupling according to claim 2, wherein each said link includes a pair of link ends, and the trace portions each include a through hole for receiving one of the link ends, the through holes being configured for orienting the links in substantially parallel relation.

4. The stripline coupling according to claim 2, wherein a first of the conductive trace sections includes a first lower conductor and a first upper conductor, a second of the conductive trace sections includes a second lower conductor and a second upper conductor, the first upper conductor and the second upper conductor comprising an upper conductor pair, the first lower conductor and the second lower conductor comprising a lower conductor pair, each said conductor including first and second opposite end portions, the conductors of one of the lower and upper conductor pairs being short circuiting together at the respective first end portions, and the conductors of the one conductor pair being cross-coupled to the conductors of the other conductor pair at the respective second end portions.

5. The stripline coupling according to claim 4, wherein the second end portions includes links extending therefrom for facilitating the cross-coupling, the second end portions of the conductors of one of the lower and upper conductor pairs each including at least one finger for receiving one of the links, the finger of one of the fingered conductors being staggered relative to the finger of the other fingered conductor for orienting the links in substantially parallel relation.

6. The stripline coupling according to claim 2, wherein a first of the trace sections comprises a first planar conductor spiral, and a second of the trace sections comprises a second planar conductor spiral, the first and second conductor spirals together comprising a stripline.

7. The stripline coupling according to claim 1, wherein the opposite-phase signals are equal in magnitude, and one of the conductive traces of the balun-configured stripline is grounded for providing the equal magnitude signals.

8. A stripline transformer including an input and an output, the transformer comprising:
a first conductive trace section;
a second conductive trace section broadside-coupled with the first conductive trace section, each said conductive trace section including a pair of substantially abutting non-contacting conductive trace portions, the conductive trace portions of one of the trace sections including at least one finger extending from said respective trace portion, the fingers of one of the fingered trace portions being interlaced with the fingers of the other fingered trace portion; and
a plurality of links extending between the fingers of the one trace section and the trace portions of the other trace section for cross-coupling the trace portions together, the conductive traces being in communication with the input and the output and being configured, in cooperation with the links, for impedance shifting between the input and the output.

9. The stripline transformer according to claim 8, wherein each said link includes a pair of link ends, an the trace portions each include a through hole for receiving one of the link ends, the through holes being configured for orienting the links in substantially parallel relation.

10. The stripline transformer according to claim 8, wherein the first trace section comprises a first conductor pair, the second trace section comprises a second conductor pair, a first conductor of the first conductor pair and a first conductor of the second conductor pair together comprising a first broad-side coupled stripline, and a second conductor of the first conductor pair and a second conductor of the second conductor pair together comprising a second broad-side coupled stripline, the first stripline being coplanar with the second stripline.

11. The stripline transformer according to claim 10, further including a shorting link coupled between one of the conductors of the first stripline and one of the conductors of the second stripline at an end portion opposite the trace portions for short circuiting together the one conductors at the opposite end portions.

12. The stripline transformer according to claim 8, wherein the first said trace section comprises a first planar conductor spiral, the second trace section comprises a second planar conductor spiral, the first and second conductor spirals together comprising a stripline.
